(19) United States
(12) Patent Application Publication
(10) Pub. No.: US 2019/0279778 A1
(43) Pub. Date: Sep. 12, 2019

(54) Relativistic Vacuum Diode for Focusing of Electron Beam

(71) Applicant: Proton Scientific, Inc., Urbana, IL (US)

(72) Inventor: Stanislav Vasilyevich Adamenko, Kiev (UA)

(73) Assignee: Proton Scientific, Inc., Urbana, IL (US)

(21) Appl. No.: 16/353,638

(22) Filed: Mar. 14, 2019

Related U.S. Application Data
(63) Continuation of application No. 14/839,298, filed on Aug. 28, 2015, now abandoned.

(30) Foreign Application Priority Data
Sep. 2, 2014 (UA) A 2014 09639

(51) Int. Cl. G21B 3/00; H05H 1/54; H05H 15/00

(52) U.S. Cl. CPC G21B 3/006; H05H 15/00; H05H 1/54

(57) ABSTRACT

A relativistic vacuum diode (RVD) for extreme focusing of an electron beam is provided. The RVD may include an axisymmetric current-conducting vacuum chamber equipped with a demountable hatch for access into its cavity; an axisymmetric electrode assembly fixed in operative position in the central zone of the vacuum chamber. It additionally includes a plasma cathode composed of a thin central current-conducting rod and wide dielectric end element, and anode-enhancer shaped as a rod, one butt-end of which serves as a target for an electron beam. The target cross-section area is smaller, than the emitting area of said cathode's wide dielectric end element. Finally, a short-circuiter of reverse current is included in an earthed circuit of the anode-enhancer that surrounds said electrode assembly concentrically with radial clearance.

### TECHNICAL FIELD

The present disclosure relates to a structure of relativistic vacuum diodes (hereinafter RVDs) meant for the study of processes occurring with the extreme focusing of a high-power electron beam to deliver pulsed power generated energy into a micrometer-size volume of a desired target, in which thermonuclear fusion processes may proceed.

### CROSS-REFERENCE TO RELATED APPLICATION

This non-provisional U.S. patent application is a continuation of U.S. patent application Ser. No. 14/839,298, filed Aug. 28, 2015, which claims the benefit of priority from Ukrainian Patent Application. No. a 2014 09639, filed on Sep. 2, 2014, both of which are herein incorporated by reference for all that they teach, without exclusion of any portion thereof.

### BACKGROUND

The potential to focus an electron beam up to a millimeter-size in diameter in a plasma cloud ablated from the diode electrodes was theoretically considered by physicist Gerry Yonas (see G. Yonas, K. R Prestwich, J. W. Poukey, and J. R. Freeman, Physical Review Letters, V. 30, p. 164, 1973, and G. Yonas, J. W. Poukey, K. R. Prestwich, J. R. Freeman, A. J. Toepfer and M. J. Clouser, Nuclear Fusion, V, 14, p. 731, 1974). However, neither of the above-mentioned references, nor many other similar publications, give specified recommendations concerning methods and means suitable for experimental study in this research direction, which requires focusing an electron beam to a micrometer-size diameter.

Each RVD has a vacuum chamber with a cathode and an anode fixed in this chamber and connected with an electric charge integrator by means of a surge, gap. With a sufficiently great charge and a short duration discharge pulse, such diodes are capable of providing an explosive electron emission from the cathode's surface and acceleration of electrons to relativistic velocity with efficiencies of more than 90%. For the purposes of generators and accelerators of powerful electron beams, RVDs have been the object of attention of physicists during the entire 20th century. Unfortunately, many improvements of these RVDs were aimed only at spatio-temporal energy compressions in electron beams and spatial shaping of these beams (see, for example: 1. SU 1545826; A. V. Gunin, V. F. Landl, S. D. Korovin, G. A. Mesyats and V. V. Rostov “Long-lived explosive-emission cathode for high-power microwave radiation generators”//Technical Physics Letters”, V.25 (11), 1999, pp. 922-926 and many others).

A method of electron beam focusing, which can be easily perceived by those skilled in the art based on the two sources mentioned above includes producing a needle-like anode-enhancer, a rounded spike of which serves as a target, placing the said anode enhancer in the vacuum chamber of the RVD opposite the plasma cathode and on the same geometric axis with a few millimeters gap, and providing a pulse discharge of the power source via the RVD in the focusing mode of an electron beam on the surface of the target. The RVD for electron beam focusing by this method comprises a vacuum chamber that has a housing made from a current-conducting material, a removable cover and a means for connection to a vacuum pump, and fixed in the chamber practically on the same geometric axis an axisymmetric plasma cathode connected, in operative position, to a pulsed high-voltage generator (hereinafter PHVG), and an axisymmetric grounded anode-enhancer, in operative position, immediately via all current-conducting housing of the vacuum chamber.

The plasma cathode has a current-conducting rod converging in the direction of the anode-enhancer and the dielectric end element, where the perimeter and the operative butt-end area of this dielectric end element are no greater than the respective perimeter and the cross-sectional area of the rod. Shaping of the electrodes in such specific geometric forms allows suppression of the pinch in the RVD gap and sharpening of the electron beam for its focusing on a small portion of the anode-enhancer surface,

The RVD according to the International Application PCT/UA03/00015 (priority date Aug. 14, 2002) comprises an axisymmetric vacuum chamber, which has a current-conducting housing that is equipped with a located on one its butt-end removable dielectric cover meant for access into said chamber for replacement of consumable details, and at least one opening for connection of said chamber to a vacuum pump, as necessary. The RVD also comprises an axisymmetric plasma cathode and an axisymmetric anode-enhancer mounted with an adjustable gap in the said vacuum chamber practically on the same geometric axis, where the distance from this geometric axis to the inner side of said current-conducting housing is greater than 50 dₘₐₓ, where dₘₐₓ is a maximum cross-sectional dimension of the anode-enhancer.

The plasma cathode is fixed within the housing and composed of a current-conducting rod connected, in operative position, to a PHVG, and an emitter of electrons in the form of a dielectric end element provided onto said rod, the emitting area of which is more than the maximum cross-sectional area of the anode-enhancer. The anode-enhancer is shaped as round in the cross-section current-conducting rod, which has a spheroidal operative butt-end that serves as a target in the operative position and which is grounded immediately via all said current-conducting housing of the vacuum chamber and further via a housing of a PHVG that connected with the RVD in operative position. Optionally, the anode-enhancer tail part can be equipped with a replaceable disposable polished shield, which is entirely made from a current-conducting material.

During preparation of the RVD to regular discharge of mentioned PHVG, the anode-enhancer has placed opposite the plasma cathode emitting area with such experimentally selected gap, at which the center of curvature of its spheroidal or plane operative butt-end was located within focal space of a focused electron beam. Such RVD together with the PHVG ensures super-short (preferably less than 20 ns) current pulses that able to generate high-power focused electron beam,

All patent specifications based on the PCT/UA03/00015 include the Table I, where data concerning permissible dimensions of dielectric end elements of plasma cathode, operative butt-ends of the anode-enhancer and inter-electrode gaps are given. Keeping these dimensions ensures practically hit of a center of each anode target into the focal space of the focused electron beam. However, grounding the anode-enhancer directly via all said current-conducting housing of the vacuum chamber lengthens route of reverse current and have a bad influence on inductance of experimental system in whole. Correspondingly, duration of pulse discharge of the PHVG via the inter-electrode gap of the RVD and energy consumption increase.

### SUMMARY OF THE DISCLOSURE

The present disclosure concentrates by—improvement of the outline of reverse current within the vacuum chamber—on creating such RVD for extreme focusing of electron beams, in which the length of the reverse current route in the earth circuit of an anode-enhancer would be shortcut and, respectively, the influences of inductance of a vacuum chamber on inductance of experimental system as a whole would be substantially decreased.

This described RVD for extreme focusing of electron beam comprises: (1) an axisymmetric vacuum chamber made from a current-conducting material and confined by a cylindrical shell ring that is equipped with one butt flange, a removable cover that fixed onto said flange and equipped in proper midportion with a demountable hatch for access into the said chamber cavity, and a partition that has at least one through-hole and separates, in its operative position, said cavity from an adjacent buffer cavity communicating with a vacuum line; (2) an axisymmetric electrode assembly that fixed in operative position in the central zone of said vacuum chamber; and (3) a short-circuiter of reverse current.

The axisymmetric electrode assembly comprises first and second parallel dielectric plates having, central openings, the geometrical axes of both of which are coincident with the symmetry axis of the vacuum chamber, with the first dielectric plate located opposite said removable cover and second dielectric plate located opposite said partition of this chamber, and further includes at least two oppositely located dielectric uprights, which rigidly couple said dielectric plates; a plasma cathode, composed of a central current-conducting rod connecting, in operative position, to a pulsed high-voltage generator and a dielectric end element that gotten coaxially onto said central rod, at that area of operative butt-end of said dielectric element exceeds cross-section area of said central rod; a clamper of the plasma cathode that fixed in said central opening of said second dielectric plate and has a termination point for connection of this cathode, in operative position, to a pulsed high-voltage generator; an anode-enhancer in the form of a rod of solid material, one butt-end of which serves, in operative position, as a target for an electron beam, at that maximal cross-section area of this anode-enhancer is less than emitting area of said dielectric end element of the plasma cathode; and a clamper of the anode-enhancer that inserted into said central opening of said first dielectric plate and has a termination point for connection of this anode-enhancer, in operative position, to a grounded circuit.

The short-circuiter of reverse current surrounds concentrically with radial clearance said electrode assembly and has first and second flanges made from a non-ferromagnetic current-conducting material; these flanges rigidly coupled by at least three spaced with equal angular distances copper buses having identical heights and cross-sections, at that said first flange in operative position connected electrically with said anode-enhancer via its clamper, and second flange connected mechanically and electrically, in operative position, with the partition of said vacuum chamber. Inclusion above-described short-circuiter into structure of the RVD allows appreciably (approximately twice) to reduce general inductance of experimental system in whole. This ensures to sharp discharge impulse front, to increase useful power in a resistive part of the RVD power circuit approximately in three times, to increase rate of a power rise in an active part of the RVD power circuit no less than in 1.3 times, and to increase efficiency of beam focusing.

A first additional feature provides that the vacuum chamber is equipped with at least one viewing window. This allows observing processes and results of electron beam focusing in experiments.

A second additional feature provides that the anode-enhancer is placed next the said target. The anode-enhancer includes a mushroom body having a flat and round in plan view head and a hollow stem that clings close to a tail part of the anode-enhancer in operative position; a cylindrical hoop, which envelopes said head of the mushroom body using sliding fit and which has a circular radial flange directed at geometrical axis of this hoop, a spring washer that is closely fitted, in operative position, by its lower flat butt-end to the upper flat butt-end of said head of the mushroom body and by its side face to the inside of said cylindrical hoop, and a replaceable disposable anode shield that made from metallic foil and restrained, in operative position, between lower flat butt-end of said head of the mushroom body and said circular radial flange of said cylindrical hoop.

A third additional feature provides that said dielectric plates and said dielectric uprights of said electrode assembly made from rigid polymeric material selected from group of polycaproamide, polycarbonate and polypropylene.

A fourth additional feature provides in that said dielectric uprights of the electrode assembly have round cross-section and transversely undulating surface. This lengthens route of possible breakdown current and, thereby, decreases considerably probability of accidental disruption along the side surfaces of said dielectric uprights.

A fifth additional feature provides that said dielectric end element of the plasma cathode has a central through-hole, at that its diameter is less than diameter of said central current-conducting rod of this cathode. This facilitates generation of an electron plasma shell with electron work function nearing zero nearby the operative butt-end of said dielectric end element.

A sixth additional feature provides that said flanges of the short-circuiter of reverse current made from accessible stainless steel.

### BRIEF DESCRIPTION OF THE DRAWINGS

The subject matter of the present disclosure will now be explained by detailed description of an improved RVD and use of it for extreme electron beam focusing with references to the accompanying drawings, in which:

FIG. 1 shows the RVD (longitudinal section by symmetry plane);

FIG. 2 shows an electrode assembly;

FIG. 3 shows an anode-enhancer, which is equipped with a replaceable disposable shield (axonometric view in an expanded scale having a partial recess); and

FIG. 4 shows a short-circuiter of reverse current in an earth circuit of the anode-enhancer (axonometric view in a slightly reduced scale).

### DETAILED DESCRIPTION

For the purpose of this description, the following terms as employed herein and in the appended claims refer to the following concepts:

“Plasma cathode” is such axisymmetric negative electrode of the RVD that has a replaceable (if it will be worn-out) dielectric end element, which is able (in the beginning of the discharge pulse) to generate an electron plasma shell (from the near-surface layer of the dielectric end element) with electron work function nearing zero; “anode-enhancer” is a single use axisymmetric positive electrode of the RVD that is made from solid material being the very target to evaluate the efficiency of electron beam focusing; and

“Focal space” is such a portion of the RVD space, which spatially confines a certain length of the common geometric symmetry axis of the RVD electrodes and in which occurs a collective focusing of relativistic electrons and the electron beam embraces a target practically uniformly.

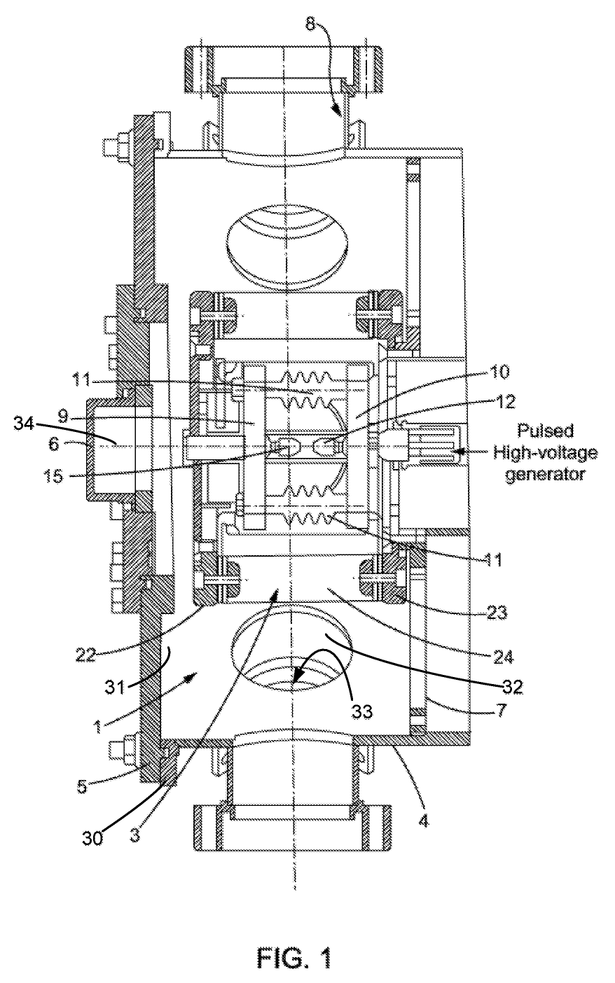

The improved RVD (see FIG. 1) has made from a current-conducting material an axisymmetric vacuum chamber 1, where an axisymmetric electrode assembly 2 and such axisymmetric short-circuiter 3 of reverse current, which envelopes said assembly 2, are concentrically mounted.

Said vacuum chamber 1 confined by—

A cylindrical shell ring 4 that is equipped at its one butt by non-specified flange;

A removable cover 5 that rigidly fixed (especially, screwed) to the above-mentioned flange of said cylindrical shell ring 4 and equipped in proper midportion with a demountable hatch 6 for access into said vacuum chamber 1 for maintenance of the electrode assembly 2, and

A partition 7 that has at least one non-specified through-hole and separates, in operative position, a cavity of said vacuum chamber 1 from a located next (and also non-specified) buffer cavity communicating with a vacuum line.

Optionally, the vacuum chamber 1 can be equipped with at least one viewing window 8 (but preferably, by two or more such windows, which blocked usually by blast-proof glasses).

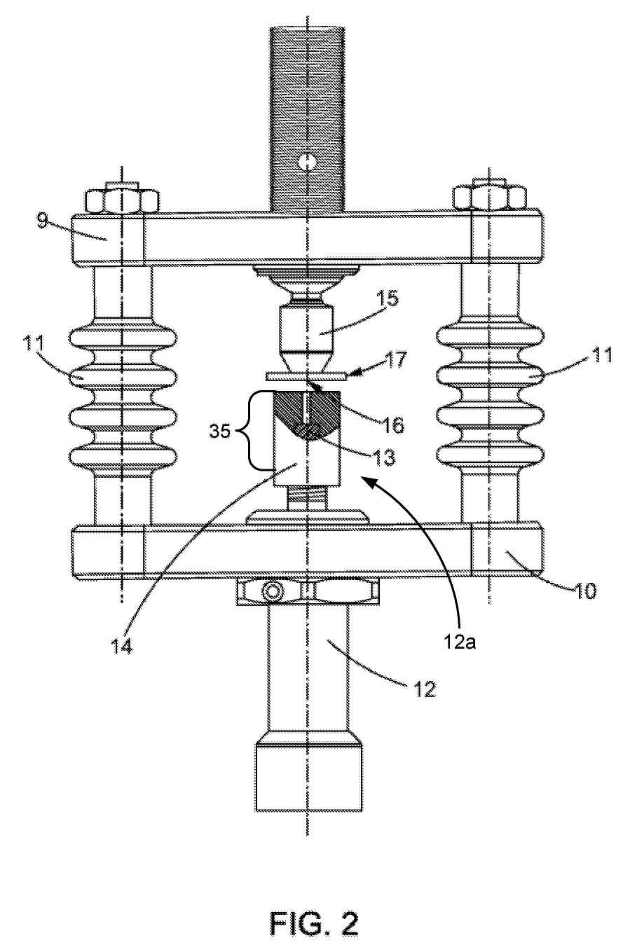

Said electrode assembly 2 has (see FIG. 2);

First (arranged opposite the cover 5) and second (arranged opposite the partition 7) parallel dielectric plates 9 and 10 having not shown and non-specified especially central openings, geometrical axes both of which are coincident with symmetry axis of the vacuum chamber 1;

Preferably two oppositely located and usually round in cross-section vertical dielectric uprights 11, which rigidly couple said dielectric plates 9 and 10 (these uprights 11 have, as a rule, transversely undulating surface for lengthening of possible breakdown current);

A clamper 12 of a described below plasma cathode (this clamper 12 is fixed in above-mentioned central opening of said second dielectric plate 10 and has a not specified termination point for connection of this cathode to a PHVG);

A plasma cathode that fixed in the clamper 12 and composed of a central current-conducting rod 13, which is connected, in operative position, to the PHVG, and a dielectric end element 14, which is coaxially gotten onto said rod 13; and

A such clamper 15 of anode-enhancer 16, that inserted (particularly, screwed) into above-mentioned central opening of said first dielectric plate 9 with possibility of adjusting reciprocal motion and has a non-specified current-conducting termination point for connection of said anode-enhancer 16 to the described in detail below short-circuiter 3 of reverse current.

Said plates 9 and 10 and said uprights 11 can make usually from such rigid polymeric materials as polycaproamide, polycarbonate, polypropylene etc.

The dielectric end element 14 of the plasma cathode can be made from a carbon-chain polymer with single carbon-carbonic bonds, e.g. from high-molecular high-density polyethylene or from polypropylene, and has usually a non-specified central through-hole, diameter of which is less than diameter of said central current-conducting rod 13.

It has manifestly showed on FIG. 2 that emitting area of operative butt-end of the dielectric end element 14 of the plasma cathode exceeds appreciably (desirably in 5-10 times) a cross-section area of the current-conducting rod 13 of said cathode and, still more appreciably, a cross-section area of said anode-enhancer 16.

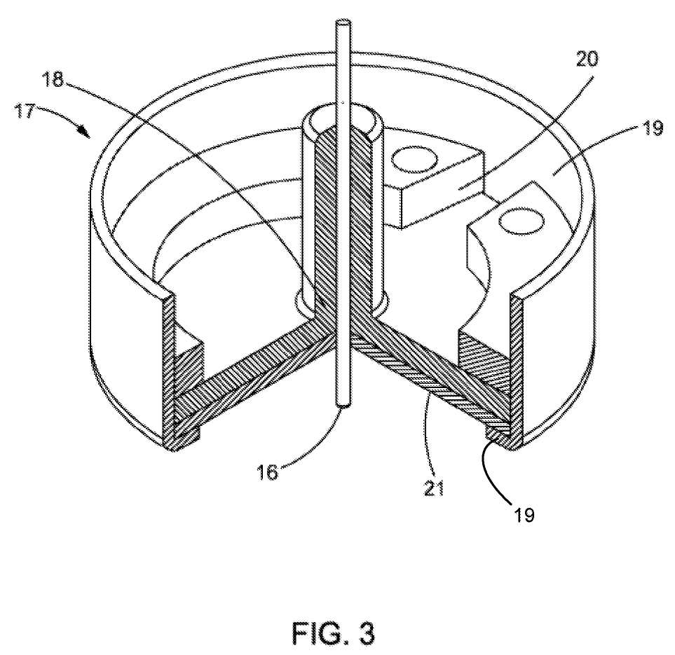

The anode-enhancer 16 (see FIG. 3) rod made from solid desirable (but non-obligatory) current-conducting material, including pure metals (e.g. copper, tantalum, nickel etc.), metal alloys and other solid organic and inorganic materials. An operative butt-end of the anode-enhancer 16 serves, in operative position, as target for an electron beam, at that a maximal cross-section area of this target is substantially less than the cross-section area of said dielectric end element 14 of the plasma cathode.

As a rule, the anode-enhancer 16 is equipped with an anode plate 17 that must be arranged next the target. This anode plate 17 comprises—

A mushroom body 18 having a non-specified flat and round in plan view head and an also non-specified hollow stem that clings close a tail part of the anode-enhancer 16 in operative position;

A cylindrical hoop 19, which envelopes a peripheral part of above-mentioned head of the mushroom body 18 using sliding fit and which has a circular radial flange directed at geometrical axis of this hoop 19,

A spring washer 20 that is closely fitted, in operative position, by its lower flat butt-end to the upper flat butt-end of above-mentioned head of the mushroom body 18 and by its side face to the inside of said cylindrical hoop 19, and

A replaceable disposable shield 21 that made from suitable metallic (usually copper) foil and restrained, in operative position, between lower flat butt-end of above-mentioned head of the mushroom body 18 and above-mentioned circular radial flange of said cylindrical hoop 19.

Above-mentioned International Application PCT/UA03/00015 includes an advice that the shield 21 must have diameter no less than 5dₘₐₓ and must be placing away the operative butt-end of the anode-enhancer 16 at distance no more than 20dₘₐₓ, where dₘₐₓ is the maximum cross dimension of said anode-enhancer 16. This advice is true in relation to the present disclosure.

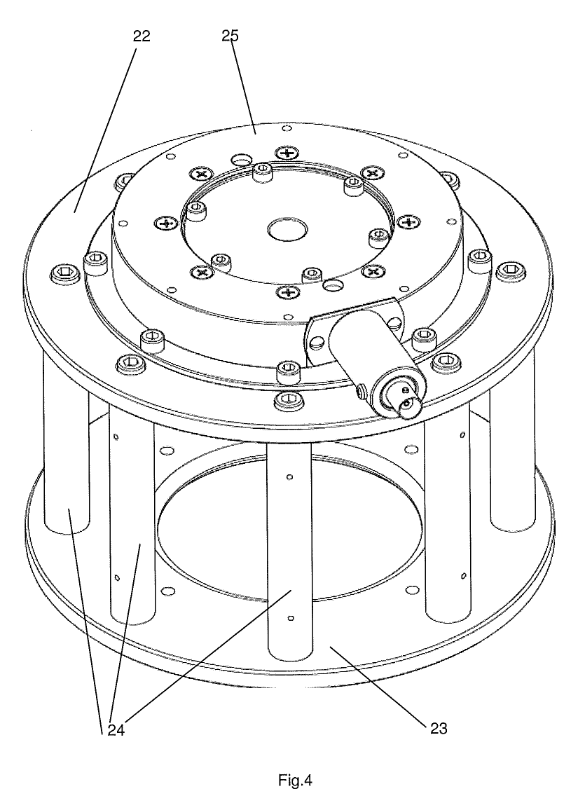

Said short-circuiter 3 of reverse current surrounds concentrically with radial clearance said electrode assembly 2 and has (see FIG. 4) first (arranged opposite the cover 5) and second (arranged opposite the partition 7) parallel flanges 22 and 23 made from a non-ferromagnetic current-conducting material (usually from stainless steel). These flanges 22 and 23 have non-specified especially central openings, geometrical axes both of which are coincident with symmetry axis of said vacuum chamber 1 and are rigidly coupled by at least three spaced with equal angular distances copper buses having identical heights and cross-sections.

First flange 22 may have a proper cover 25 and has connected electrically, in operative position, to the anode-enhancer 16 via said clamper 15.

Second flange 23 has fastened, it operative position, to the partition 7 of the vacuum chamber 1 and contacts electrically with this partition 7. Above-mentioned central opening at least in the first flange 22 must have such diameter, which is sufficient for the purpose of free bringing in and removal of the electrode assembly 2.

A pulsed high-voltage generator (PHVG) for power supply of the RVD is a system that is well-known for any person skilled in the art (see, for example: 1. P. F. Ottinger, J. Appl. Phys., 56, No. 3, 1984; 2. [symbol] [symbol] - [symbol] [symbol] , 24, [symbol] 12, c.1078, 1984—In English—Dolgachev G. I. et al—Physics of Plasma, 24, No. 12 p. 1078, 1984). Therefore, it has not shown on the drawings. This system comprises connected in series—

An input transformer equipped with a means for connection to an industrial network and a high-voltage output winding,

A storage EC-circuit comprising accessible capacitors and inductors, and

An unit for plasma interruption of discharge current in the LC-circuit composed of a set of well-known to each person skilled in the art plasma guns symmetrically located in one plane, the number of which (up to 12, in particular) usually being equal to the number of capacitors in the LC-circuit.

Besides of previously mentioned power units, the PHVG incorporates well-known means for measuring pulse current and voltage, such as at least one Rogovski belt and at least one capacitive voltage divider.

For purpose of electron beam focusing using the described RVD, following steps must be realized—

(1) Cutting a stem made from selected solid substance (particularly, in the form of a wire having diameter in the range from 0.5 to 1.0 mm) into a set of such cut-to-length sections, each of which must have length sufficient for reliable fastening in the clamper 15 and further must serve as an anode-enhancer 16;

(2) Buffing a target on one end of each anode-enhancer 16;

(3) Optionally, installation of the above-described anode plate 17, in which disposable shield 21 has beforehand inserted, on the anode-enhancer 16;

(4) Installation of a selected dielectric end element 14 on the central current-conducting rod 13 of above-mentioned plasma cathode;

if a set of single-type experiments must perform, the step (4) performs only at initiation of such set or at revelation of an inadmissible wear of the dielectric end element 14.

(5) Fixation of the mounted plasma cathode in the clamper 12;

(6) Placement of the anode-enhancer 16 (optionally together with said catcher 17) into the clamper 15;

(7) Screwdriving of the clamper 15 together with the anode-enhancer 16 into above-mentioned opening of first dielectric plate 9 of the electrode assembly 2;

At carrying out the step (7), an inter-electrode gap must adjust in good time in order to provide hit of the center of target of the anode-enhancer 16 into a focal space of the collectively focusing electron beam during a pulse discharge of a PHVG via RVD.

For example, under condition that typical average energy of electron beam is approximately 0.5 MeV, the dielectric end elements 14 of the plasma cathode having identical lengths 8.75 mm and outer diameter in the range from 16.0 to 24.0 mm, and the anode-enhancers 16, in which cross-section areas of the targets were from 0.2 mm² to 0.8 mm² in the most part of experiments. Accordingly, an inter-electrode gap had adjusted in the range from 3.0 to 6.0 mm. Then a focal space had revealed in the range from 0.10 to 0.14 mm³.

(8) Installation of the mounted electrode assembly 2 within the vacuum chamber 1 and connecting the clamper 12 of the plasma cathode to the PHVG and the clamper 15 of the anode-enhancer 16 to the short-circuiter 3 of reverse current in the grounded circuit;

(9) Closing the vacuum chamber 1 by placing the demountable latch 6 onto the cover 5;

(10) Vacuumizing the said chamber 1 that performs preferably twice (i.e. including initial pump down of air, blow-off the chamber 1 by pure dry nitrogen and repeat pump down of gases until residual pressure no more than 0.01 pascal);

(11) Connecting the PHVG to an industrial electrical grid via said input transformer and accumulation of a necessary electrical charge in the storage LC-circuit;

(12) Discharge of the storage LC-circuit via above-mentioned unit for plasma interruption of discharge current, said non-consumable central current-conducting rod 13 and the dielectric end element 14 on the RVD anode-enhancer 46 with generation of an electron beam having the electron energy no less than 0.2 MeV, current density no less than 10⁶ A/cm² (but preferably up to 10² A/cm²) and width less than 30 as;

(13) Smooth equalization of pressure in the vacuum chamber 1 with atmosphere;

(14) Opening of the vacuum chamber 1 by removal of the demountable hatch 6 from the cover 5;

(15) Removal the used electrode assembly 2 from the vacuum chamber 1;

This final step can substantially simplify using the catcher 17. It takes off the anode-enhancer 16, and then the spring washer 20 squeezes, the cylindrical hoop 19 moves along above-mentioned round head of the mushroom body 18 and the catching shield 21 carefully extracts from a gap between said head and the circular radial flange of the cylindrical hoop 19.

### INDUSTRIAL APPLICABILITY

Any proposed RVD for electron beam focusing may be produced from accessible on world market materials and utilities. Any such RVD can use for laboratory studies of applications that require extreme electron beam focusing, such as x-ray radiography and thermonuclear fusion applications.

What is claimed is:

1. A relativistic vacuum diode for extreme electron beam focusing, comprising:
an axisymmetric vacuum chamber made from a current-conducting material and confined by a cylindrical shell ring that is equipped with one butt flange, a removable cover fixed on said flange and equipped in proper midportion with a demountable hatch for access into a cavity internal to the chamber, and a partition that has at least one through-hole and separates, in operative position, said cavity from an adjacent buffer cavity communicating with a vacuum line;
an axisymmetric electrode assembly fixed in the central zone of said vacuum chamber and comprising:
first and second parallel dielectric plates having central openings, geometrical axes of both of which are coincident with a symmetry axis of said vacuum chamber, wherein the first dielectric plate is located opposite said removable cover and second dielectric plate is located opposite said partition of this chamber;
at least two oppositely located dielectric uprights, which rigidly couple said dielectric plates;
a plasma cathode, composed of a central current-conducting rod connected, in operative position, to a pulsed high-voltage generator and a dielectric end element positioned coaxially onto said central rod, wherein a cross-sectional area of an operative butt-end of said dielectric element exceeds a cross-sectional area of said central rod;
a clamper of the plasma cathode fixed in said central opening of said second dielectric plate with a termination point for connection of this cathode in operative position, to a pulsed high-voltage generator;
an anode-enhancer in the form of a rod of solid material, one butt end of which serves, in operative position, as a target for an electron beam, wherein a maximal cross-sectional area of this anode-enhancer is less than an emitting area of said dielectric end element of the plasma cathode;
a clamper of the anode-enhancer inserted into said central opening of said first dielectric plate with a termination point for connection of this anode-enhancer, in operative position, to an earthed circuit;
a short-circuiter of reverse current that surrounds concentrically with radial clearance said electrode assembly and has first and second flanges made from a non-ferromagnetic current-conducting material; these flanges rigidly coupled by at least three spaced with equal angular distances copper buses having identical heights and cross-sections, wherein the first flange in operative position is connected electrically with said anode enhancer via its clamper, and the second flange is connected mechanically and electrically, in operative position, with the partition of said vacuum chamber.

2. The relativistic vacuum diode according to claim 1, wherein vacuum chamber is equipped with at least one viewing window.

3. The relativistic vacuum diode according to claim 1, wherein the anode-enhancer is equipped with a screen that placed next the said target; this catcher comprises
a mushroom body having a flat and round in plan view head and a hollow stem that clings close to a tail part of the anode-enhancer in operative position;
a cylindrical hoop, which envelopes said head of the mushroom body using sliding ft and which has a circular radial flange directed at geometrical axis of this hoop,
a spring washer that is closely fitted in operative position by its lower flat butt-end to the upper flat butt-end of said head of the mushroom body and by its side face to the inside of said cylindrical hoop, and
a replaceable disposable shield that made from metallic foil and restrained in operative position between lower flat butt-end of said head of the mushroom body and said circular radial flange of said cylindrical hoop.

4. The relativistic vacuum diode according to claim 1, wherein said dielectric plates and said dielectric uprights of said electrode assembly made, from rigid polymeric material selected from group consisting of polycaproamide, polycarbonate and polypropylene.

5. The relativistic vacuum diode according to claim 1, wherein said dielectric uprights of the electrode assembly have round cross-section and transversely undulating surface.

6. The relativistic vacuum diode according to claim 1, wherein said dielectric end element of the plasma cathode has a central through-hole, at that its diameter is less than diameter of said central current-conducting rod of this cathode.

7. The relativistic vacuum diode according to claim 1, wherein said flanges of the short-circuiter of reverse current made from stainless steel.
